(19) United States
(12) Patent Application Publication
(10) Pub. No.: US 2010/0069223 A1
(43) Pub. Date: Mar. 18, 2010

(54) METHOD FOR THE PREPARATION OF CERAMIC MATERIALS

(76) Inventors: Emanual Prilutsky, Kiev (UA); Oleg Prilutsky, Kibbutz Ruhama (IL); Dan Yardeni, Ramat Gan (IL)

Correspondence Address: Pearl Cohen Zedek Latzer, LLP, 1500 Broadway, 12th Floor, New York, NY, 10036, US

(21) Appl. No.: 12/544,673

(22) Filed: Aug. 20, 2009

Related U.S. Application Data
(63) Continuation-in-part of application No. PCT/IL2008/000228, filed on Feb. 21, 2008.
(60) Provisional application No. 60/905,512, filed on Mar. 7, 2007.
(60) Provisional application No. 61/159,605, filed on Mar. 12, 2009.

(51) Int. Cl. C04B 35/565; C01B 33/021; C04B 35/56; C04B 35/58; C04B 35/583; C04B 35/584

(52) U.S. Cl. 501/88; 423/349; 501/87; 501/96.1; 501/96.4; 501/97.1

(57) ABSTRACT

A novel process for the preparation of boron carbide, boron nitride and silicon carbide powders comprises carbidization or nitrization step of boron oxide or silicon oxide respectively, using nanoparticles substrates.

### CROSS REFERENCE TO RELATED APPLICATIONS

This is a continuation-in-part application of PCT International Application No. PCT/IL2008/000228, International Filing Date Feb. 21, 2008, entitled “Method for the preparation of ceramic materials”, published on Aug. 28, 2008 as International Publication No. WO 2008/102357 that in turn claims priority from U.S. Provisional Application No. 60/905,512, filed Feb. 22, 2007, both of which are incorporated herein by reference. In addition, this application claims priority from U.S. Provisional Application No. 61/159,605, filed Mar. 12, 2009, which is incorporated herein by reference.

### FIELD OF THE INVENTION

This invention is directed to novel and useful process for the preparation of boron carbide, boron nitride and silicon carbide comprising carbidization or nitrization step of boron oxides or silicon oxides, using nanoparticles substrates.

### BACKGROUND OF THE INVENTION

Ceramic materials including boron carbide (B₄C), silicon carbide (SiC), silicone nitride (Si₃N₄) and boron nitride (BN) have useful properties including high melting temperature, low density, high strength, stiffness, hardness, wear resistance, and corrosion resistance. Many ceramics are good electrical and thermal insulators.

For most applications using ceramics, a fine powder with small particle size down to nano-sized particles are required. Small particle-size powders are not easily obtained by current methodology and usually require additional grinding and cleaning operations.

Boron Carbide (B₄C) is a black crystalline material and is one of the hardest materials known, ranking third behind diamond and cubic boron nitride. Boron Carbide powder is mainly produced by reacting carbon with boric oxide in an electric arc furnace, through carbothermal reduction or by gas phase reactions. For commercial use, boron carbide powders usually need to be milled, and purified to remove metallic impurities.

Boron carbide may be used in several applications, for example as an abrasive, where due to its high hardness; boron carbide powder is useful in polishing and lapping applications.

Boron carbide may also find application in the preparation of nozzles or ballistic armors where the extreme hardness of boron carbide gives it excellent wear and abrasion resistance and as a consequence it finds application in nozzles used in slurry pumping, grit blasting and in water jet cutters.

Boron carbide may also be useful in nuclear applications, for its ability to absorb neutrons without forming long lived radio-nuclides which makes the material attractive as an absorbent for neutron radiation. Nuclear applications of boron carbide include shielding, control rods and shut down pellets.

Silicon nitride (Si₃N₄) is a hard solid substance, and is the main component in silicon nitride ceramics, which have good shock resistance as well as other mechanical and thermal properties. Therefore, ball bearings made of silicon nitride ceramic are used in performance bearings. Silicon nitride ball bearings are harder than metal, which reduces contact with the bearing track. This results in less friction, less wasted energy and higher speed. They are also much lighter and more durable than metal bearings under steady loads. Silicon nitride ball bearings can be found in high end automotive bearings, industrial bearings and wind turbines.

Silicon nitride is also used as an ignition source for domestic gas appliances, hot surface ignition. In microelectronics, silicon nitride is usually used either as an insulator layer to electrically isolate different structures or as an etch mask in bulk micromachining. It is also used as a dielectric between polysilicon layers in capacitors in analog chips.

Bulk, monolithic silicon nitride is used as a material for cutting tools, due to its hardness, thermal stability, and resistance to wear. It is especially recommended for high speed machining of cast iron. For machining of steel, it is usually coated by titanium nitride (usually by CVD) for increased chemical resistance.

Silicon nitride can be obtained by direct reaction between silicon and nitrogen at high temperatures. Electronic-grade silicon nitride is usually formed using chemical vapor deposition (CVD), or one of its variants, such as plasma-enhanced chemical vapor deposition (PECVD).

Silicon carbide (SiC) is man-made for use as an abrasive or more recently as a semiconductor and moissanite gemstones. Silicon carbide is known as a wide bandgap semiconductor existing in many different polytypes. All polytypes have a hexagonal frame with a carbon atom situated above the center of a triangle of Si atoms and underneath a Si atom belonging to the next layer, this affects all electronic and optical properties of the crystal. All polytypes are extremely hard, very inert and have a high thermal conductivity. Properties such as the breakdown electric field strength, the saturated drift velocity and the impurity ionization energies are all specific for the different polytypes. The simplest manufacturing process of SiC is to combine silica sand and carbon at a high temperature in electric furnaces, between 2000° C. and 2500° C.

Carbidization in general and carbidization of silicon or boron comprise formation of SiC or B₄C on a surface of carbon particles, wherein such carbon particles are large, and a layer of carbides is formed on the carbon outer layer and requires elevated temperature to form carbides on the inner layer of the carbon particles.

Boron nitride (BN) is a white powder with high chemical and thermal stability and high electrical resistance. Boron nitride possesses three polymorphic forms; one analogous to diamond, one analogous to graphite and one analogous to fullerenes. Boron nitride can be used to make crystals that are extremely hard, second in hardness only to diamond, and the similarity of this compound to diamond extends to other applications. Like diamond, boron nitride acts as an electrical insulator but is an excellent conductor of heat.

Boron nitride has ability to lubricate (qualities similar to graphite) in extreme cold or heat, is suited to extreme pressure applications, environmentally friendly and inert to most chemicals powders

Due to its excellent dielectric and insulating properties, BN is used in electronics e.g. as a substrate for semiconductors, microwave-transparent windows, structural material for seals, electrodes and catalyst carriers in fuel cells and batteries.

The synthesis of hexagonal boron nitride powder is achieved by nitrization or ammonalysis of boric oxide at elevated temperature. Cubic boron nitride is formed by high pressure, high temperature treatment of hexagonal BN.

Single crystal fibers are crystal whiskers, filamentary crystals or acicular crystals which are small, needle-shaped single crystal fibers of refractory elements (i.e., oxides, carbides, nitrides and borides) that exhibit exceptional mechanical properties in addition to other useful features.

Single crystal fibers are used for reinforcements for various matrices. When added to castable metals, the single crystal fibers stiffen and harden the alloy. The addition of single crystal fibers to ceramic matrices provides ceramics that possess improved properties of high mechanical strength and toughness at both room temperature and elevated temperatures. Other applications include field emitters, microfabrication tools, planar light traps, etc.

The diameter of the single crystal fibers can sometimes be as small as 0.3 microns and the length is frequently within the 10 to 30 micron range.

While current ceramics applications are well known, there is a need in the art to develop an efficient, higher quality and cheaper method for the preparation of ceramic materials, especially including high content of single crystal fibers and generating fine particles powder.

### SUMMARY OF THE INVENTION

In one embodiment, this invention provides a process for the preparation of ceramic materials comprising carbides or nitrides, wherein the process comprising the step of carbidizing or nitridizing a metal or metalloid, whereby:
a. the carbidizing or nitridizing comprises heating the metal oxide or metalloid oxide in an inert atmosphere or a nitrogen atmosphere together with nanoparticles substrates, wherein the carbidizing at a temperature not to exceed 1900° C., and the nitridizing at a temperature not to exceed 1500° C.; and
b. the nanoparticles substrates have a diameter which does not exceed 50 nm.

In one embodiment, this invention provides a process for the preparation of boron carbide (B₄C) comprising the step of carbidizing boron, whereby:
a. the carbidizing comprises heating boron oxide and carbon particles in an inert atmosphere, at a temperature not to exceed 1900° C.; and
b. the carbon particles have a diameter which does not exceed 50 nm.

In one embodiment, this invention provides a process for the preparation of boron carbide (B₄C) comprising the following steps:
a. dehydrating an aqueous solution of boric acid or boron salt and a carbohydrate to obtain boron oxide and carbon particles;
b. carbidizing boron by heating boron oxide and carbon particles of step (a) in an inert atmosphere, wherein
   the carbidizing is conducted at a temperature not to exceed 1900° C.; and
   the carbon particles have a diameter which does not exceed 50 nm.

In one embodiment, this invention provides a process for the preparation of silicon carbide (SiC) comprising the step of carbidizing silicon, whereby:
a. the carbidizing comprises heating silicon oxide and carbon particles in an inert atmosphere, at a temperature not to exceed 1900° C.; and
b. the carbon particles have a diameter which does not exceed 50 nm.

In one embodiment, this invention provides a process for the preparation of silicon carbide (SiC) comprising the following steps:
a. dehydrating an aqueous solution of silicic acid or silicon salt and a carbohydrate to obtain silicon oxide and carbon particles;
b. carbidizing by heating silicon oxide and carbon particles of step (a) in an inert atmosphere, wherein
   the carbidizing is conducted at a temperature not to exceed 1900° C.; and
   the carbon particles have a diameter which does not exceed 50 nm.

In one embodiment, this invention provides a process for the preparation of silicon nitride (Si₃N₄) comprising the step of nitridizing silicon, whereby:
a. the nitridizing comprises heating silicon oxide and carbon particles in a nitrogen atmosphere, at a temperature not to exceed 1500° C.; and
b. the carbon particles have a diameter which does not exceed 50 nm.

In one embodiment, this invention provides a process for the preparation of silicon nitride (Si₃N₄) comprising the following steps:
a. dehydrating an aqueous solution of silicic acid or silicon salt and a carbohydrate to obtain silicon oxide and carbon particles;
b. nitridizing by heating silicon oxide and carbon particles of step (a) in a nitrogen atmosphere, wherein
   the nitridizing is conducted at a temperature not to exceed 1500° C.; and
   the carbon particles have a diameter which does not exceed 50 nm.

In one embodiment, this invention provides a process for the preparation of boron nitride (BN) comprising the following steps:
a. dehydrating an aqueous solution of boric acid or boron salt, carbamide and a carbohydrate to obtain penta-borateamonium hydrate, and carbon particles;
b. heating boron of the penta-borateamonium hydrate and carbon particles of a step (a) under N₂ to obtain B₄C, wherein the heating is conducted at a temperature not to exceed 1500° C.; and
c. nitridizing the B₄C of a step (b) under nitrogen wherein
   the nitridizing is conducted at a temperature not to exceed 1500° C.; and
   the B₄C have a diameter which does not exceed 50 nm.

### BRIEF DESCRIPTION OF THE DRAWINGS

FIGS. 1a and 1b depict a Scanning Electron Micrographs of different Forms of single crystal fibers B₄C.

FIG. 2 depicts a Scanning Electron Micrographs of Isometeric rombohedral and platelet like crystals of B₄C.

FIG. 3 depicts a Scanning Electron Micrographs of single icosahedral crystal of B₄C.

FIG. 4 depicts a Scanning Electron Micrographs of isometric nanocrystals of B₄C.

FIG. 5 depicts a Scanning Electron Micrographs of isometric nanocrystals after grinding of B₄C.

FIG. 6 depicts a Scanning Electron Micrographs of B₄C wherein up to 50% of the particles are single crystal fibers and platelet like crystals.

FIG. 7 depicts a Scanning Electron Micrographs of SiC powder enlarged by A) 10,000; B) 40,000; C) 60,000 and D) 200,000

FIG. 8 depicts a Scanning Electron Micrographs of BN nanoparticles powder.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In one embodiment, this invention provides a process for the preparation of ceramics comprising carbides or nitrides. In another embodiment, the ceramics are boron carbide (B₄C), silicon carbide (SiC), silicon nitride (Si₃N₄) or boron nitride (BN).

In one embodiment, this invention provides a process for the preparation of ceramics, wherein the process yields ceramic particles in controlled size manner. In another embodiment, the process yields ceramic particles in the range of between 1-100 microns. In another embodiment, the ceramic particles in the range of 25 nm to 10 μm.

In one embodiment, this invention provides a process for the preparation of ceramics, wherein the process yields ceramic particles in controlled crystalline structure manner. In one embodiment the ceramics are in single crystal fiber structure. In another embodiment the ceramics are in platelet crystal structures. In another embodiment the ceramics are in an isometric rombohedral crystal structures. In another embodiment the ceramics are in an isometric crystal structures. In another embodiment the ceramics are in icosahedral crystal structures or any combination thereof.

In one embodiment, this invention provides a process for the preparation of ceramics, wherein the process yields ceramic particles in high purity level. In another embodiment, the purity of the ceramics of this invention is above 97%. In another embodiment, the purity of the ceramics of this invention is in the range of between about 98-100%. In another embodiment, the purity of the ceramics of this invention is in the range of between about 97-100%. In another embodiment, the purity of the ceramics of this invention is in the range of between about 99-100%.

In one embodiment, this invention provides a process for the preparation of ceramic materials comprising carbides or nitrides, wherein the process comprising the step of carbidizing or nitridizing a metal or metalloid, whereby:
a. the carbidizing or nitridizing comprises heating the metal oxide or metalloid oxide in an inert atmosphere or a nitrogen atmosphere together with nanoparticles substrates, wherein the carbidizing at a temperature not to exceed 1900° C., and the nitridizing at a temperature not to exceed 1500° C.; and
b. the nanoparticles substrates have a diameter which does not exceed 50 nm.

In one embodiment the processes of this invention provides a carbidization or nitrization step of metal or metalloid. In another embodiment the metal may be tungsten, calcium, sodium. In another embodiment the term metalloid refers to chemical elements having both metals and nonmetals properties. In another embodiment, the metalloids may be silicon, boron, germanium, arsenic, antimony or tellurium.

In one embodiment, this invention provides a process for the preparation of boron carbide (B₄C) comprising the step of carbidizing boron, whereby:
a. carbidizing comprises heating boron oxide and carbon particles in an inert atmosphere, at a temperature not to exceed 1900° C.; and
b. the carbon particles have a diameter which does not exceed 50 nm.

In one embodiment, this invention provides a process for the preparation of boron carbide (B₄C) comprising the steps of:
a. dehydrating an aqueous solution of boric acid or boron salt and a carbohydrate to obtain boron oxide and carbon particles;
b. carbidizing boron by heating boron oxide and carbon particles of step (a) in an inert atmosphere, wherein
   the carbidizing is conducted at a temperature not to exceed 1900° C.; and
   the carbon particles have a diameter which does not exceed 50 nm.

In one embodiment of this invention, according to any process of this invention, dehydrating comprises the steps of
a. drying aqueous solution of boric acid or boron salt and a carbohydrate at a temperature not to exceed 200° C.;
b. caramelizing of boric acid or boron salt and a carbohydrate of step (a) at a temperature not to exceed 400° C.; and
c. carbonizing of the product of (b), in an inert atmosphere, at a temperature ranging from about 400-600° C.

In one embodiment, this invention provides a process for the preparation of silicon carbide (SiC) comprising the step of carbidizing silicon, whereby:
a. carbidizing comprises heating silicon oxide and carbon particles in an inert atmosphere, at a temperature not to exceed 1900° C.; and
b. the carbon particles have a diameter which does not exceed 50 nm.

In one embodiment, this invention provides a process for the preparation of silicon carbide (SiC) comprising the steps of:
a. dehydrating an aqueous solution of silicic acid or silicon salt and a carbohydrate to obtain silicon oxide and carbon particles;
b. carbidizing silicon by heating silicon oxide and carbon particles of step (a) in an inert atmosphere, wherein
   the carbidizing is conducted at a temperature not to exceed 1900° C.; and
   the carbon particles have a diameter which does not exceed 50 nm.

In one embodiment, this invention provides a process for the preparation of silicon nitride (Si₃N₄) comprising the step of nitridizing silicon, whereby:
a. nitridizing comprises heating silicon oxide and carbon particles in a nitrogen atmosphere, at a temperature not to exceed 1900° C.; and
b. the carbon particles have a diameter which does not exceed 50 nm.

In one embodiment, this invention provides a process for the preparation of silicon nitride (Si₃N₄) comprising the steps of:
a. dehydrating an aqueous solution of silicic acid or silicon salt and a carbohydrate to obtain silicon oxide and carbon particles;
b. nitridizing silicon by heating silicon oxide and carbon particles of step (a) in a nitrogen atmosphere, wherein
   the nitridizing is conducted at a temperature not to exceed 1500° C.; and
   the carbon particles have a diameter which does not exceed 50 nm.

In one embodiment of this invention, according to any process of this invention, dehydrating comprises the steps of
a. drying aqueous solution of silicic acid or silicon salt and a carbohydrate at a temperature not to exceed 200° C.;
b. caramelizing of the silicic acid or silicon salt and carbohydrate of step (a) at a temperature not to exceed 400° C.; and
c. carbonizing of the product of (b), in an inert atmosphere, at a temperature ranging from about 400-600° C.

In another embodiment of this invention, according to any process of this invention, the carbohydrate is saccharide. In another embodiment, the saccharide used is a polysaccharide. In another embodiment the saccharide is glucose. In another embodiment the saccharide is dextrose. In another embodiment the saccharide is lactose.

In one embodiment of this invention, according to any process of this invention the boron salt is any salt or alloy comprising boron. In one embodiment of this invention, according to any process of this invention the silicon salt is any salt or alloy comprising silicon. In another embodiment a boron salt is a salt of boric acid. In another embodiment, a silicon salt is a salt of silicic acid. In another embodiment, the salts of boric acid or silicic acid include metallic salts made from alkaline metals, or alkaline earth metals, or transition metals. In another embodiment the salts of boric acid or silicic acid include organic salts such as N,N′-dibenzylethyleneldiamine, choline, chloroprocaine, diethanolamine, ethylenediamine, meglumine (N-methylglucamine) and procain.

In one embodiment, the salts may be formed by conventional means, such as by reacting the free base or free acid form of the product with one or more equivalents of the appropriate acid or base.

In one embodiment of this invention, according to any process of this invention the boric acid is selected from H₃BO₃, H₂B₄O₇ or HBO₂.

In one embodiment of this invention, according to any process of this invention the silicic acid is selected from H₂SiO₃, H₄SiO₄, H₂Si₂O₅ or H₆Si₂O₇.

In one embodiment of this invention, according to any process of this invention silicon oxide is silicon containing at least one oxygen atom. In another embodiment silicon oxide is silicon dioxide (SiO₂).

In one embodiment of this invention, according to any process of this invention boron oxide is boron containing at least one oxygen atom. In another embodiment boron oxide is boron trioxide (B₂O₃).

In one embodiment of this invention, according to any process of this invention, the drying step or dehydration step is at a temperature not to exceed 200° C. In another embodiment, the drying step is ranging from about 150-200° C. In another embodiment, the drying step is at a temperature ranging from about 160-200° C. In another embodiment, the drying step is at a temperature ranging from about 150-160° C. In another embodiment, the drying step is at a temperature ranging from about 160-170° C. In another embodiment, the drying step is at a temperature ranging from about 170-180° C. In another embodiment, the drying step is at a temperature ranging from about 180-200° C.

In another embodiment, the aqueous solution may be prepared with the use of an ultrasonic dispenser. In another embodiment, the drying step may be conducted using an atomizing dryer.

In one embodiment, caramelizing refers to the preparation of a non-crystallizable substance obtained by pyrogenation of sugars or from molasses.

In one embodiment of this invention, according to any process of this invention, caramelization is at a temperature not to exceed 400° C. In another embodiment, the caramelization is at temperature ranging from about 350-400° C. In another embodiment, carbonization is at a temperature ranging from about 350-360° C. In another embodiment, carbonization is at a temperature ranging from about 360-370° C. In another embodiment, carbonization is at a temperature ranging from about 370-380° C. In another embodiment, carbonization is at a temperature ranging from about 380-390° C. In another embodiment, carbonization is at a temperature ranging from about 390-400° C.

In one embodiment, carbonizing refers to the decomposition of organic substances by heat with a limited supply of air, whereby carbon is formed.

In another embodiment of this invention, according to any process of this invention, carbonization is at a temperature ranging from about 400-600° C. In another embodiment, carbonization is at a temperature ranging from about 450-550° C. In another embodiment, carbonization is at a temperature ranging from about 450-460° C. In another embodiment, carbonization is at a temperature ranging from about 460-470° C. In another embodiment, carbonization is at a temperature ranging from about 470-480° C. In another embodiment, carbonization is at a temperature ranging from about 480-490° C. In another embodiment, carbonization is at a temperature ranging from about 490-500° C. In another embodiment, carbonization is at a temperature ranging from about 500-510° C. In another embodiment, carbonization is at a temperature ranging from about 510-520° C. In another embodiment, carbonization is at a temperature ranging from about 520-530° C. In another embodiment, carbonization is at a temperature ranging from about 530-540° C. In another embodiment, carbonization is at a temperature ranging from about 540-550° C. In another embodiment, carbonization is at a temperature ranging from about 500-600° C. In another embodiment, carbonization is at a temperature ranging from about 550-600° C. In another embodiment, carbonization is at a temperature ranging from about 500-550° C.

In one embodiment, carbidizing refers to reaction between a carbon atom and one or more metalloid or metal elements.

In one embodiment, nitridizing refers to reaction between nitrogen and one or more metalloid or metal elements.

In one embodiment of this invention the B₄C powder obtained having chemical properties as described in Example 1.

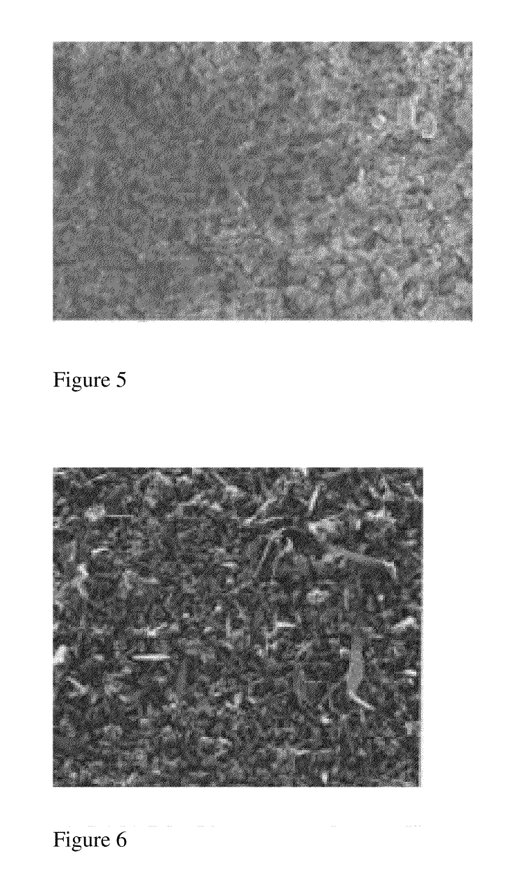

In another embodiment of this invention according to any process of this invention, B₄C powder obtained having chemical properties as described in Example 2 and presented in FIGS. 1-6.

In one embodiment, preparation of B₄C via a process as described herein, B₄C following hot pressing of the powder, includes anti-ballistic properties as presented in Example 4.

In another embodiment hot pressing refers to applying pressure at high temperature to enhance densification. In another embodiment, hot pressing is conducted by placing a powder and applying uniaxial pressure while the entire system is held at an elevated temperature. In another embodiment B₄C particles after hot pressing include an average grain size of between 3.5-7.5 μm, hardness of between 2630-3800 kg/mm², and minimum bulk density of 2.5 g/cm³.

In another embodiment of this invention, for any process of this invention, carbidization may be performed at a temperature which does not exceed 1900° C. In another embodiment the temperature may be at a range of between 1600-1850° C. In another embodiment of this invention, the temperature of carbidization is between 1700-1800° C. In another embodiment, the temperature of carbidization is between 1650-1700° C. In another embodiment, the temperature of carbidization is between 1700-1750° C. In another embodiment, the temperature of carbidization is between 1750-1800° C. In another embodiment, the temperature of carbidization is between 1800-1850° C.

In another embodiment of this invention, for any process of this invention, carbidization comprises reacting boron oxide or silicon oxide and carbon particles with a heating rate of between 80-180° C./min. In another embodiment the heating rate is between 80-90° C./min. In another embodiment, the heating rate is between 90-100° C./min. In another embodiment, the heating rate is between 100-110° C./min. In another embodiment, the heating rate is between 110-120° C./min. In another embodiment, the heating rate is between 120-130° C./min. In another embodiment, the heating rate is between 130-140° C./min. In another embodiment, the heating rate is between 140-150° C./min. In another embodiment, the heating rate is between 150-160° C./min. In another embodiment, the heating rate is between 160-170° C./min. In another embodiment, the heating rate is between 170-180° C./min.

In another embodiment of this invention, for any process of this invention, nitridization may be performed at a temperature which does not exceed 1500° C. In another embodiment the temperature may be at a range of between 1200-1450° C. In another embodiment of this invention, the temperature of nitridization is between 1400-1450° C. In another embodiment, the temperature of nitridization is between 1350-1400° C. In another embodiment, the temperature of nitridization is between 1300-1350° C. In another embodiment, the temperature of nitridization is between 1250-1300° C. In another embodiment, the temperature of nitridization is between 1450-1500° C.

In another embodiment of this invention, for any process of this invention, nitridization comprises reacting boron oxide or silicon oxide and carbon particles in a nitrogen atmosphere with a heating rate of between 80-180° C./min. In another embodiment the heating rate is between 80-90° C./min. In another embodiment, the heating rate is between 90-100° C./min. In another embodiment, the heating rate is between 100-110° C./min. In another embodiment, the heating rate is between 110-120° C./min. In another embodiment, the heating rate is between 120-130° C./min. In another embodiment, the heating rate is between 130-140° C./min. In another embodiment, the heating rate is between 140-150° C./min. In another embodiment, the heating rate is between 150-160° C./min. In another embodiment, the heating rate is between 160-170° C./min. In another embodiment, the heating rate is between 170-180° C./min.

In another embodiment of this invention, for any process of this invention, the w/w ratio of boron trioxide or silicon dioxide and carbon particles is in between about 1.78-1.86:1. In another embodiment, the ratio is between about 1.78-1.79:1. In another embodiment, the ratio is between about 1.79-1.8:1. In another embodiment, the ratio is between about 1.8-1.81:1. In another embodiment, the ratio is between about 1.81-1.82:1. In another embodiment, the ratio is between about 1.82-1.83:1. In another embodiment, the ratio is between about 1.83-1.84:1. In another embodiment, the ratio is between about 1.84-1.85:1. In another embodiment, the ratio is between 1.85-1.86:1.

In another embodiment of this invention, for any process of this invention, the w/w ratio of silicon dioxide and carbon particles is in between about 1.69-1.71:1. In another embodiment the w/w ratio of silicon dioxide and carbon particles is in between about 1.65-1.75:1. In another embodiment the w/w ratio of silicon dioxide and carbon particles is in between about 1.65-1.70:1. In another embodiment the w/w ratio of silicon dioxide and carbon particles is in between about 1.68-1.72:1. In another embodiment the w/w ratio of silicon dioxide and carbon particles is in between about 1.66-1.73:1. In another embodiment the w/w ratio of silicon dioxide and carbon particles is in between about 1.6-1.8:1

In another embodiment of this invention, in any process of this invention, the carbon particles used are nano particles. In another embodiment according to any process of this invention the nano particles are derived from nanotubes, nanofibers or a combination thereof. In another embodiment, according to any process of this invention, the diameter of the nanotubes or the nanofibers carbon particles ranges from about 5-20 nm. In another embodiment the diameter of the nanotubes, nanofibers, or any combination thereof is about between 10-20 nm. In another embodiment the diameter of the nanotubes, nanofibers, or any combination thereof is about between 15-30 nm. In another embodiment the diameter of the nanotubes, nanofibers, or any combination thereof is about between 30-50 nm.

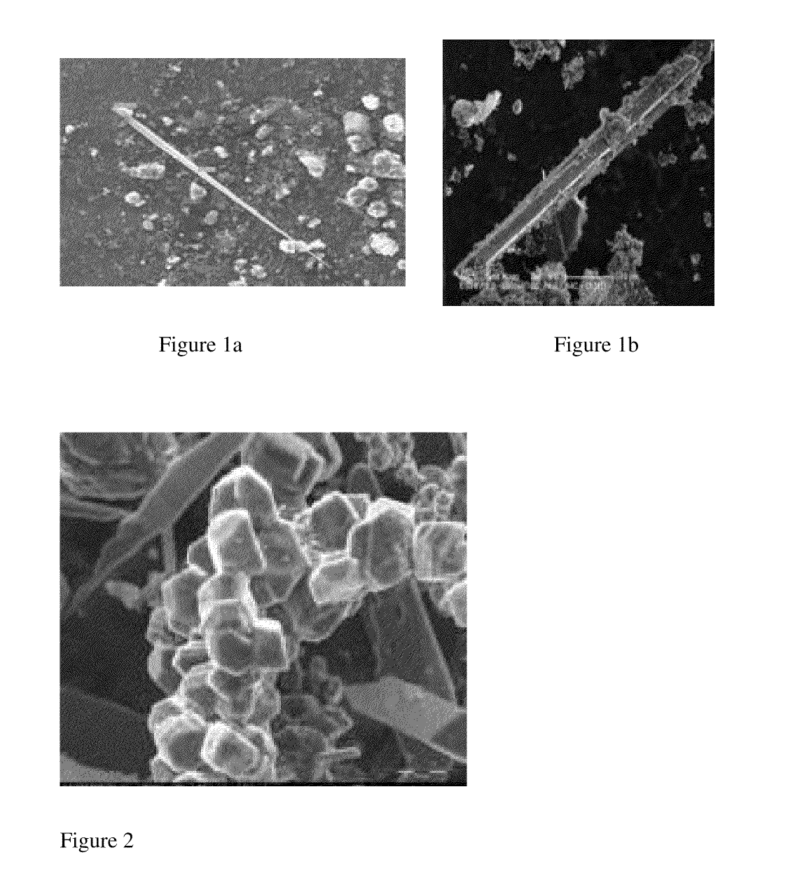

In one embodiment of this invention, the particles of boron carbide obtained by any process of this invention are single crystal fibers with dimensions of between of 0.2×2 μm to 30×200 μm. In another embodiment of this invention, the particles of boron carbide obtained by any process of this invention are in a platelet crystalline form with dimensions of between of 2×2×0.3 μm to 100×100×3 μm. In another embodiment of this invention, the particles of boron carbide obtained by any process of this invention are isometric nanocrystals with dimensions of between of 25 nm to 10 μm. In another embodiment of this invention, the particles of boron carbide obtained by any process of this invention are isometric nanocrystals with dimensions of between of 25 nm to 10 μm or any combination thereof. In another embodiment a mixture of isometric and platelet crystals are obtained as presented in FIG. 2.

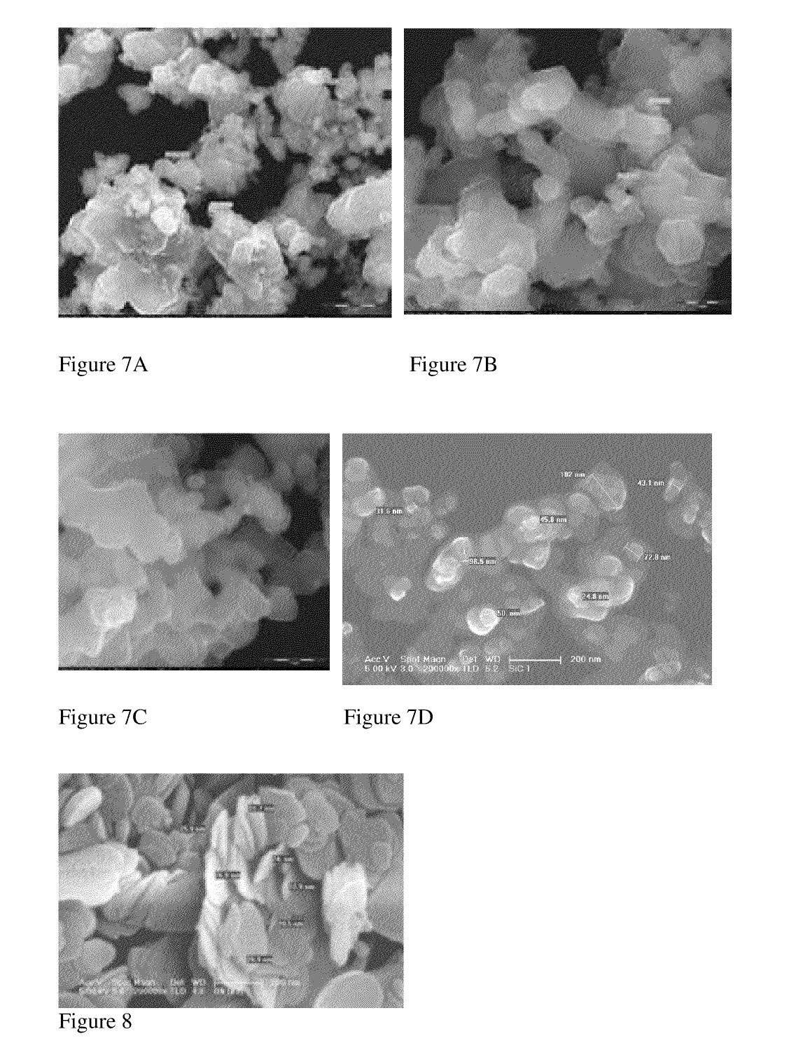

In one embodiment of this invention, the particles of silicon carbide obtained by any process of this invention are single crystal fibers with dimensions of between of 0.2×2 μm to 30×200 μm. In another embodiment of this invention, the particles of silicon carbide obtained by any process of this invention are in a platelet crystalline form with dimensions of between of 2×2×0.3 μm to 100×100×3 μm. In another embodiment of this invention, the particles of silicon carbide obtained by any process of this invention are isometric nanocrystals with dimensions of between of 25 nm to 10 μm or any combination thereof. In another embodiment SiC particles are obtained as presented in FIG. 7.

In one embodiment of this invention, this invention provides a process for the preparation of boron carbide (B₄C) enriched with single crystal fibers comprising the step of carbidizing boron, comprising the steps of
a. dehydrating an aqueous solution of boric acid or boron salt and a carbohydrate to obtain boron oxide and carbon particles;
b. carbidizing silicon by heating boron oxide and carbon particles of step (a) in an inert atmosphere, wherein
   the carbidizing is conducted at a temperature not to exceed 1900° C.; and
   the carbon particles have a diameter which does not exceed 50 nm.

In one embodiment of this invention, this invention provides a process for the preparation of silicon carbide (SiC) enriched with single crystal fibers comprising the step of carbidizing boron, comprising the steps of:
a. dehydrating an aqueous solution of silicic acid or silicon salt and a carbohydrate to obtain silicon oxide and carbon particles;
b. carbidizing silicon by heating silicon oxide and carbon particles of step (a) in an inert atmosphere, wherein
   the carbidizing is conducted at a temperature not to exceed 1900° C.; and
   the carbon particles have a diameter which does not exceed 50 nm.

In one embodiment of this invention the process for the preparation of boron carbide (B₄C) enriched with single crystal fibers further comprises the step of isolating the single crystal fibers. In another embodiment the single crystal fibers are sized such that the ratio of the length of the fiber axis versus the diameter of the fiber is at least 10.

In one embodiment, this invention provides a process for the preparation of boron nitride (BN) comprising the step of nitrization of boron, whereby the nitrization comprises heating carbamide, carbohydrate and boric acid in an inert atmosphere, at a temperature not to exceed 1600° C.

In one embodiment, this invention provides a process for the preparation of boron nitride (BN) comprising the following steps:
a. dehydrating an aqueous solution of boric acid or boron salt, carbamide and a carbohydrate to obtain Penta-borateamonium hydrate, and carbon particles;
b. heating boron of the penta-borateamonium hydrate and carbon particles of a step (a) under N₂ to obtain B₄C, wherein the heating is conducted at a temperature not to exceed 1500° C.; and
c. nitridizing the B₄C of a step (b) under nitrogen wherein
   the nitridizing is conducted at a temperature not to exceed 1500° C.; and
   the B₄C have a diameter which does not exceed 50 nm.

In one embodiment, the process for the preparation of boron nitride comprises a carbamide, boric acid and carbohydrate. In another embodiment the carbamide is urea. In another embodiment the carbohydrate is sacharide.

In one embodiment of this invention the BN powder obtained has chemical and physical properties as described in Example 3 and presented in FIG. 8.

In another embodiment of this invention, for any process of this invention, nitrization may be performed at a temperature which does not exceed 1500° C. In another embodiment the temperature may be at a range of between 1300-1450° C. In another embodiment of this invention, the temperature of nitrization is between 1400-1500° C. In another embodiment, the temperature of nitrization is between 1200-1500° C. In another embodiment, the temperature of nitrization is between 1250-1350° C. In another embodiment, the temperature of nitrization is between 1400-1450° C. In another embodiment, the temperature of nitization is between 1450-1500° C.

In another embodiment of this invention, for any process of this invention, nitrization comprises reacting carbamide, carbohydrate and boric acid with a heating rate of between 80-180° C./min. In another embodiment the heating rate is between 80-90° C./min. In another embodiment, the heating rate is between 90-100° C./min. In another embodiment, the heating rate is between 100-110° C./min. In another embodiment, the heating rate is between 110-120° C./min. In another embodiment, the heating rate is between 120-130° C./min. In another embodiment, the heating rate is between 130-140° C./min. In another embodiment, the heating rate is between 140-150° C./min. In another embodiment, the heating rate is between 150-160° C./min. In another embodiment, the heating rate is between 160-170° C./min. In another embodiment, the heating rate is between 170-180° C./min.

In another embodiment of this invention, for any process of this invention, the ratio (w/w) between the boric acid (H₃BO₃), urea (NH₂)₂CO and saccharide (C₁₂H₂₂O₁₁) is (11:26:1) up to 13:23:1, respectively. In another embodiment, the ratio (w/w) between the boric acid and sacharide is in the range of 11.5-12.5:1, respectively. In another embodiment, the ratio (w/w) between the boric acid and sacharide is in the range of 11-12:1, respectively. In another embodiment, the ratio (w/w) between the boric acid and sacharide is in the range of 12-13:1 respectively.

In one embodiment of this invention, the particles of boron nitride obtained by any process of this invention are crystal whiskers with dimensions of between of 0.2×2 μm to 30×200 μm. In another embodiment of this invention, the particles of boron nitride obtained by any process of this invention are in a platelet crystalline form with dimensions of between of 2×2×0.3 μm to 100×100×3 μm. In another embodiment of this invention, the particles of boron nitride obtained by any process of this invention are isometric nanocrystals with dimensions of between of 25 nm to 10 μn, or any combination thereof.

In one embodiment of this invention, according to any process of this invention, the process further includes separation of the different crystalline forms of the B₄C of this invention. In another embodiment of this invention, according to any process of this invention, the single crystal fiber Form of B₄C can be isolated from other crystalline or amorphous B₄C Forms by means known in the art such as sedimentation. In another embodiment of this invention, according to any process of this invention, the isometric crystal Forms of B₄C can be isolated from other crystalline or amorphous B₄C Forms by means known in the art such as sedimentation. In another embodiment of this invention, according to any process of this invention, the platelet crystal Forms of B₄C can be isolated from other crystalline or amorphous B₄C Forms by means known in the art such as sedimentation.

In one embodiment of this invention, according to any process of this invention, the process further includes separation of the different crystalline forms of the SiC of this invention. In another embodiment of this invention, according to any process of this invention, the crystal whiskers Form of SiC can be isolated from other crystalline or amorphous SiC Forms by means known in the art such as sedimentation. In another embodiment of this invention, according to any process of this invention, the isometric crystal Forms of SiC can be isolated from other crystalline or amorphous SiC Forms by means known in the art such as sedimentation. In another embodiment of this invention, according to any process of this invention, the platelet crystal Forms of SiC can be isolated from other crystalline or amorphous SiC Forms by means known in the art such as sedimentation.

In one embodiment of this invention, according to any process of this invention, the process further includes separation of the different crystalline forms of the BN of this invention. In another embodiment of this invention, according to any process of this invention, the crystal whiskers Form of BN can be isolated from other crystalline or amorphous BN Forms by means known in the art such as sedimentation. In another embodiment of this invention, according to any process of this invention, the isometric crystal Forms of BN can be isolated from other crystalline or amorphous BN Forms by means known in the art such as sedimentation. In another embodiment of this invention, according to any process of this invention, the platelet crystal Forms of BN can be isolated from other crystalline or amorphous BN Forms by means known in the art such as sedimentation.

In one embodiment of this invention, according to any process of this invention, the process further includes grinding the ceramics. In another embodiment of this invention, according to any process of this invention, the boron carbide, silicon carbide, silicon nitride or boron nitride particles following grinding range in size from about 15-100 nm. In another embodiment of this invention, according to any process of this invention, the boron carbide, silicon carbide, silicon nitride or boron nitride particles following grinding range in size from about 70-80 nm. In another embodiment of this invention, according to any process of this invention, the boron carbide, silicon carbide, silicon nitride or boron nitride particles following grinding range in size from about 80-100 nm. In another embodiment of this invention, according to any process of this invention, the boron carbide, silicon carbide, silicon nitride or boron nitride particles are obtained after a short grinding period, and are between about 50-80 nm in diameter characterized by granulometric analysis. In another embodiment, the granulation analysis is performed by ball milling.

In one embodiment grinding refers to any means by which the B₄C undergoes size reduction into fine particles.

In one embodiment this invention provides a boron carbide, silicon carbide, silicon nitride or boron nitride preparation obtained by a process of this invention comprises at least 5% single crystal fibers. In another embodiment, a boron carbide, silicon carbide, silicon nitride or boron nitride preparation obtained by a process of this invention comprises at least 10% single crystal fibers, or in another embodiment, at least 11% single crystal fibers of boron carbide, silicon carbide, silicon nitride or boron nitride, or in another embodiment, at least 12% single crystal fibers of boron carbide, silicon carbide, silicon nitride or boron nitride, or in another embodiment, at least 15% single crystal fibers boron carbide, silicon carbide, silicon nitride or boron nitride, or in another embodiment, at least 17% single crystal fibers boron carbide, silicon carbide, silicon nitride or boron nitride, or in another embodiment, at least 20% single crystal fibers of boron carbide, silicon carbide, silicon nitride or boron nitride, or in another embodiment, at least 25% single crystal fibers of boron carbide, silicon carbide, silicon nitride or boron nitride, or in another embodiment, at least 30% single crystal fibers of boron carbide, silicon carbide, silicon nitride or boron nitride, or in another embodiment, at least 40% single crystal fibers of boron carbide, silicon carbide, silicon nitride or boron nitride. In another embodiment of this invention, boron carbide, silicon carbide, silicon nitride or boron nitride preparation obtained by a process of this invention comprises from about 10% to about 30% single crystal fibers.

In another embodiment, 80% of the isolated single crystal fibers comprise a ratio of the length of the crystals versus their cross section as being not less than 10. In another embodiment, 80% of the isolated single crystal fibers comprise a ratio of the length of the crystals versus their cross section, as being not less than 20.

In one embodiment the single crystal fibers obtained by a process of this invention are filamentary crystals. In another embodiment the single crystal fibers are acicular crystals. In another embodiment the single crystal fibers are in a lamellar form. In another embodiment the single crystal fibers are in a platelet form. In one embodiment the single crystal fibers obtained by a process of this invention are crystal whiskers.

In another embodiment, the inert gas in the processes of this invention may be argon or helium.

A further embodiment of this invention, is the preparation of solar grade silicon (SOG-Si) from silicon carbide (SiC) or silicon nitride (Si₃N₄), particularly silicon carbide and silicon nitride prepared according to any of the processes of this invention. According to one embodiment, SOG-Si is prepared from SiC according to any one or both of the following reactions:

SiC+CO₂→Si+2CO

SiC+H₂O→Si+CO+H₂

According to one embodiment, the temperature for preparing SOG-Si from SiC is at least about 1000° C.

According to another embodiment, SOG-Si is prepared from Si₃N₄ by heating to a temperature above about 1850° C., according to the following reaction:

Si₃N₄→3Si+2N₂

According to one embodiment, the SOG-Si may be prepared on a substrate, thereby forming a SOG-Si coating or film on the substrate. According to another embodiment, the prepared SOG-Si may be in the form of cylinders, or any other appropriate form.

Various aspects of the invention are described in greater detail in the following Examples, which represent embodiments of this invention, and are by no means to be interpreted as limiting the scope of this invention.

### EXAMPLES

### Example 1

### Chemical Properties of B₄C Powders

The following table presents the chemical properties of B₄C powders:

### Chemical Formula—B₄C;

Density—2.52 g/cm³
Grade Available—high purity B₄C powder for hot pressing, filling, etc.
Chemical Characteristics (% mass.):

| | |
|---|---|
| Boron Carbide | ≧97 |
| B:C Ratio | 3.8-4.2 |
| Total Carbon¹ | 20 min |
| Mg, Mn, Ni, Ti, W² | <0.002 |
| Iron² | <0.02 |
| O | <0.9 |
| N | <1.0 |
| Al | <0.01 |
| Si | <0.01 |
| Ca | <0.05 |

¹chemical analysis
²Spectrum analysis

### Example 2

### Physical Properties of B₄C

The following table presents the physical properties of B₄C powders

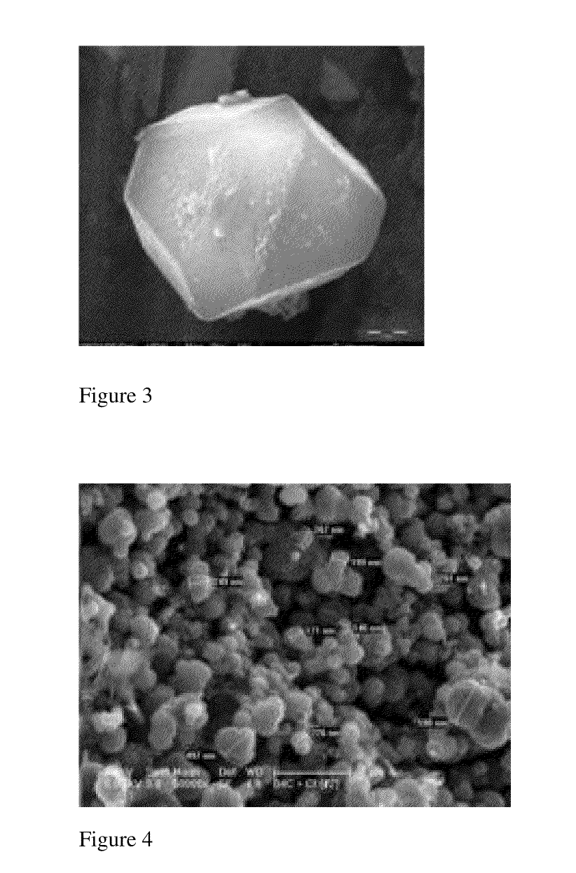

### Physical Characteristics:

| Particle Size³ | 100% <10 microns after |
|---|---|
| | grinding |
| The form of crystals: | Typical Values, % |
| Crystal Whiskers^{3,5} as presented in FIG. 1 | 20% min |
| Platelet single crystal^{3,5} | 10% min |
| Isometric crystal^{3,5}; as presented in FIG. 3 | Remainder to 100% |
| and 4 | |
| Thickness of Whiskers and Platelets | <2 microns |
| Ratio length/width | 10-100 |
| Surface Area⁴ | 2-9 m²/g |

³Laser Nanosizer, deglomeration in pure alcohol with high energy ultrasonic before analysis;
⁴Method BET
⁵SEM

### Example 3

### Chemical and Physical Properties of BN Powders

The following table presents the chemical properties of BN powders:

### Chemical Formula—BN;

Grade Available—ultra high purity, high surface area, sub-micron BN powder.
Chemical Characteristics (% mass.):

| | |
|---|---|
| Boron Nitride | ≧99.75 |
| Total Boron¹ | 43.40-43.60 |
| Total Nitrogen¹ | 56.35-56.45 |
| Sum Total of alkaline metals² | <5 * 10⁻⁴ |
| Iron² | <1 * 10⁻³ |

The following table presents the physical properties of BN powders, as presented in FIG. 8:

### Physical Characteristics:

| Particle Size³ | 100% <3 microns |
|---|---|
| Particle Size Distribution | Typical Values |
| D90 | 1.75 |
| D50 | 0.7 |
| D10 | 0.2 |
| Mean particle | 0.66 microns |
| Surface Area⁴ | 15-20 m²/g |

¹Chemical Analysis;
²Spectrum Analysis;
³Laser Nanosizer, deglomeration in pure alcohol with high energy ultrasonic before analysis;
⁴Method BET

### Example 4

### Ballistic Tests Results

A ballistic test was performed using a bullet with the steel thermally—strengthened core in the steel core of the caliber of 7.62 mm (B-32), a mass of 1.5 g. The distance between the caliber and the B₄C (monoblock—10×12 inch, thickness of B₄C—8 mm, prepared by hot pressing) was 10 m, angle of traverse −0° with respect to the standard. Shots were produced into the apexes of equilateral triangle with the side 100 mm.

The results of the test are:

| | | | Sincebarrier |
|---|---|---|---|
| # | Speed of bullet, m/s | result | Deformation, mm |
| 1 | 840 | impenetrable | 18 |
| 2 | 855 | impenetrable | 20 |
| 3 | 850 | impenetrable | 15 |

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A process for the preparation of ceramics comprising carbides, wherein said process comprising the step of carbidizing or a metal or metalloid, whereby:
a. said carbidizing comprises heating said metal oxide or metalloid oxide in an inert atmosphere together with carbon particles, at a temperature not to exceed 1900° C.; and
b. said carbon particles have a diameter which does not exceed 50 nm.

2. A process for the preparation of ceramics comprising nitrides, wherein said process comprising the step of nitridizing a metal or metalloid, whereby:
a. said nitridizing at a temperature not to exceed 1500° C.; and
b. said carbon particles have a diameter which does not exceed 50 nm.

3. The process of claim 1, wherein said metalloid is boron or silicon.

4. The process of claim 1, wherein said metal is calcium, sodium, iron or tungsten.

5. The process of claim 1, wherein the temperature is at a range of between 1600-1850° C.

6. The process of claim 2, wherein said temperature is at a range of between 1200-1450° C.

7. The process according to claim 1, wherein the carbide is boron carbide (B₄C) and wherein the metalloid is boron.

8. The process according to claim 7 comprising a preliminary step of
dehydrating an aqueous solution of boric acid or boron salt and a carbohydrate to obtain boron oxide and carbon particles.

9. The process of claim 8, wherein said dehydrating comprises the steps of:
a. drying aqueous solution of boric acid or boron salt and a carbohydrate at a temperature not to exceed 200° C.;
b. caramelizing of said boric acid or boron salt and carbohydrate of step (a) at a temperature not to exceed 400° C.; and
c. carbonizing of the product of (b), in an inert atmosphere, at a temperature ranging from about 400-600° C.

10. The process according to claim 1, wherein the carbide is silicon carbide (SiC) and the metalloid is silicon.

11. The process according to claim 2, wherein the nitride is silicon nitride (Si₃N₄) and the metalloid is silicon.

12. The process according to claim 10 comprising a preliminary step of
dehydrating an aqueous solution of silicic acid or silicon salt and a carbohydrate to obtain silicon oxide and carbon particles.

13. The process of claim 12, wherein said dehydrating comprises the steps of:
a. drying aqueous solution of silicic acid or silicon salt and a carbohydrate at a temperature not to exceed 200° C.;
b. caramelizing of said silicic acid or silicon salt and carbohydrate of step (a) at a temperature not to exceed 400° C.; and
c. carbonizing of the product of (b), in an inert atmosphere, at a temperature ranging from about 400-600° C.

14. The process according to claim 11 comprising a preliminary step of
dehydrating an aqueous solution of silicic acid or silicon salt and a carbohydrate to obtain silicon oxide and carbon particles.

15. The process of claim 14, wherein said dehydrating comprises the steps of:
a. drying aqueous solution of silicic acid or silicon salt and a carbohydrate at a temperature not to exceed 200° C.;
b. caramelizing of said silicic acid or silicon salt and carbohydrate of step (a) at a temperature not to exceed 400° C.; and
c. carbonizing of the product of (b), in an inert atmosphere, at a temperature ranging from about 400-600° C.

16. The process according to claim 2 further comprising the following preliminary steps:
a. dehydrating an aqueous solution of boric acid or boron salt carbamide and a carbohydrate to obtain penta-borateamonium hydrate, and carbon particles;
b. heating boron of said penta-borateamonium hydrate and carbon particles of a step (a) under N₂ to obtain B₄C, wherein said heating is conducted at a temperature not to exceed 1500° C.; and
wherein the nitridizing of said B₄C is under nitrogen.

17. A process for preparing solar grade silicon (SOG-Si) from SiC prepared according to claim 10.

18. A process for preparing solar grade silicon (SOG-Si) from Si₃N₄ prepared according to claim 11.

19. A process for preparing solar grade silicon (SOG-Si) from SiC prepared according to claim 12.

20. A process for preparing solar grade silicon (SOG-Si) from Si₃N₄ prepared according to claim 14.

21. The process according to claim 17, wherein the SOG-Si is prepared by reacting SiC with CO₂, H₂O, or a mixture thereof, in a temperature of about more than 1000° C.

22. The process according to claim 18 wherein the SOG-Si is prepared by heating Si₃N₄ to a temperature of about more than 1850° C.

23. The process of claim 2, wherein said metalloid is boron or silicon.

24. The process of claim 2, wherein said metal is calcium, sodium, iron or tungsten.
